(19) United States
(12) Patent Application Publication
(10) Pub. No.: US 2004/0051659 A1
(43) Pub. Date: Mar. 18, 2004

(54) Vehicular situational awareness system

(76) Inventor: Darwin A. Garrison, Brunswick, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/246,437

(22) Filed: Sep. 18, 2002

(51) Int. Cl. G01S 13/93

(52) U.S. Cl. 342/70; 342/71; 342/72; 342/52; 342/53; 342/55

(57) ABSTRACT

A plurality of sensors each gather information about a region around the periphery of a motor vehicle. The sensor system is equipped with a radar assembly, an infrared detection assembly, and a visible light detection assembly. A central processing unit integrates data gathered from the three assemblies and combines them to form an aggregate data set of the individual region. The CPU also combines aggregate data sets from all the sensors and displays the information on a dashboard mounted display. The display is an active matrix display that shows contacts relative to the motor vehicle, a level of threat imposed by each individual contact, and a blink rate for color blind applications. The display takes advantage of color active matrix technology, displaying low threats as green sprites, moderate threats as yellow or orange sprites, and severe threats as red sprites.

### BACKGROUND OF THE INVENTION

The present invention relates to automotive vehicles, and, more particularly, to a near object detection system for automotive vehicles.

A commonly known problem with large commercial vehicles is safely maneuvering in traffic and in tight areas such as loading docks and the like. A driver has limited peripheral view from the cab and, even with an array of mirrors to aid the driver, blind spots are issues and leave the potential that obstacles may be overlooked.

Systems exist that warn a driver of obstacles in the vicinity of the vehicle. For example, current generation object detection systems use esoteric light emitting diode (LED) displays and audible warning signal claxons to convey information to the vehicle driver. Known LED displays provide a static, single color indication of an object detected by the system. The audible warning signals can startle or affect the concentration of the driver.

In still other systems, it is suggested that a three dimensional (3D) display or a global positioning system (GPS) be incorporated as a part of the system. Unfortunately, these systems add complexity without the desired simplicity and intuitive conveyance of data to the vehicle operator. Moreover, these systems are inexact and are not intuitively obvious to interpret, thereby taking valuable driver response time to interpret and understand.

Other object detection systems use radar. Radar based systems are excellent for identifying hard objects. However, radar is not good for soft object location such as humans or animals. A radar system, for example, does not give the driver fair warning of a deer in the highway. Moreover, radar does not provide accurate size or shape information. For example, a radar system may inform a driver that an object is in a blind spot, but the driver will not know if he is clear to change lanes.

Visible light systems have a limited range. While eyesight is often a far better tool for visualizing and quickly understanding the surroundings of the driver, visible light systems are restricted by normal hindrances to sight, such as darkness and fog, and require a clear line of sight to be useful.

Infrared systems, on the other hand, detect electromagnetic radiation, such as irradiated heat. However, objects detected in these systems typically have very low resolution, and environmental conditions such as humidity and fog may adversely impact the detection capabilities. Thus, these systems suffer from poor imaging and inaccurate object sizing, even though these systems are more effective than radar at detecting soft bodies.

### SUMMARY OF THE INVENTION

The present invention provides a new and improved method and apparatus that overcome the above referenced problems and provide a machine vision that enhances or supplements the capabilities of the driver.

In accordance with one aspect of the present invention, a near object sensor system is provided. The near object sensor includes at least two of a radar assembly, an infrared detection assembly, and a visible light detection assembly.

In accordance with another aspect of the present invention, a vehicle includes multiple near object sensors, a central processing unit for integrating views from each of the sensors, and a display for displaying the integrated views to an operator of the vehicle.

In accordance with still another aspect of the present invention, a situational awareness system is provided. The system includes a plurality of periphery sensors, each sensor including at least two of a radar assembly, an infrared detection assembly, and a visual light detection assembly. The system also includes a display for displaying information gathered by the sensors to a vehicle driver.

According to another aspect of the present invention, a method of near object detection is provided. The method includes the steps of emitting radio waves into a region, receiving reflected radio waves from objects within the region, and receiving one of infrared and visible light emissions from the region.

The present invention generally provides increased driver awareness of surroundings and identification of potential threats. The present invention further provides a multi-modality detection system that will provide images of objects that are outside the field of view of the driver and provides a display that is simple and intuitive.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a diagrammatic illustration of a sensor network in accordance with the present invention.

FIG. 2 is an illustration of a display output, in accordance with the present invention.

### DETAILED DESCRIPTION OF THE PREFERRED EMBODIMENT

The present invention finds particular application in conjunction with near object detection systems for vehicles, especially heavy automotive vehicles such as large trucks, buses, tractors, tractor-trailers, etc., and will be described with particular reference thereto. It will be appreciated, however, that the present invention is also applicable to related fields and is not limited to the aforementioned application.

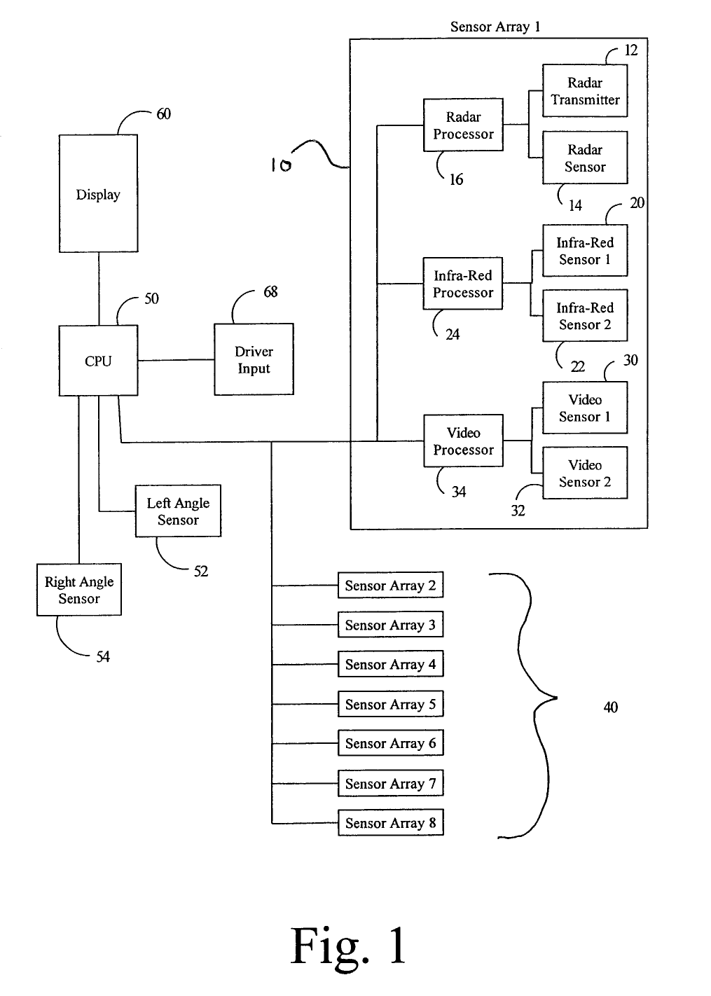

FIG. 1 illustrates a near object detector system that includes a first sensor array 10 containing a plurality of individual sensors for sensing objects near a motor vehicle. In a preferred embodiment, several like sensor arrays are disposed around the periphery of a host tractor/trailer assembly or other heavy vehicle. Each such sensor array is also referred to as a near object sensor or, because of the placement around the periphery of the vehicle, a periphery sensor. It is to be understood that sensors can likewise be disposed on a smaller automobile, aircraft, or other vehicle, and are not limited to commercial trucking applications.

The sensor array 10 includes a radio detection array or system, (RADAR) more specifically, a radar transmitter 12 and a radar sensor 14. In a preferred embodiment, the radar transmitter 12 is a directional transmitter that emits radio frequency waves in a generally cone shaped region away from the host vehicle. Objects within the region reflect a portion of the radio waves back in the direction of the host vehicle. The radar sensor 14 detects the reflected radio waves. Reflected radio waves are subsequently analyzed by a radar processor 16. The reflected radio waves are interpreted to discern individual objects. The radar processor 16 assigns a number to each individual object that it detects. In addition to identification of objects, the radar processor 16 is able to discern object position relative to the sensor array 10, object velocity relative to the sensor array 10, and a rough size of the object.

Detection capabilities of the radar processor include, but are not limited to, automotive vehicles, guardrails, retaining walls, bridges (overpasses), and doorways.

In addition to radar sensing capabilities, the sensor array 10 also includes an infrared (IR) detection array or assembly. A first infrared sensor 20 and a second infrared sensor 22 detect infrared radiation from a field of view, preferably the same region as the radar sensor 14. In a preferred embodiment, the IR sensors 20, 22 are passive sensors. That is, the IR sensors detect radiation emanating from the region, rather than emitting IR radiation and detecting reflected portions thereof. However, active IR arrays are also contemplated. The first IR sensor 20 has a slightly different view of the region than the second IR sensor 22. The two views are preferably combined by an infrared processor 24 into a single IR view. The combined view achieves a degree of three-dimensional perspective, as is well known in optics. After combining the views, the IR processor 24 calculates relative position and velocity values, as does the radar processor 16.

Infrared imaging is used to gain additional information that radar alone cannot. The IR sensors 20, 22 detect heat signatures, for example, which make the IR sensors ideal for detecting animals, such as humans and deer, that radar alone might not detect. The IR view yields a better dimensional profile than the radar, giving more definition to sizes and shapes of detected objects. IR sensors work equally well in both day and night, making the IR sensors especially valuable during nighttime driving, when the vision of the driver is more limited.

In addition to radar and IR capabilities, the sensor array 10 also includes a visible light detection array or assembly. A first visible light of video sensor 30 and a second visible light or video sensor 32 detect visible light from a field of view. Preferably, the visible light sensors 30, 32 detect objects in the same region as do the radar sensor 14 and the IR sensors 20, 22. The visible light sensors 30, 32 may be any conventional sensor capable of detecting visible light from a field of view, such as a camera. In a preferred embodiment, the visible light sensors 30, 32 are charged couple device (CCD) cameras. Alternately, other types of visible light sensors or cameras could be used without departing from the scope and intent of the present invention.

Preferably, the first visible light sensor 30 has a slightly different view of the region than the second visible light sensor 32. The two views are combined by a visible light or video processor 34 into a single visible light combined view. Similar to the IR combined view, the visible light combined view gains a measure of depth perception, as is known in optics. After the visible light processor 34 combines the views, it calculates a velocity of the detected object relative to the sensor array 10 and a position of the object relative thereto, as do the radar processor 16 and the IR processor 24.

The visible light sensor array defines sharp boundaries of detected objects, yielding high spatial resolution. Dimensions of detected objects are accurately computed. The visible light view also detects lane lines on the road, providing a frame of reference for the view, aiding range finding and velocity tracking. The visible light view is less influenced than IR by selected environmental conditions such as extremely hot road conditions. The visible light view provides an accurate indication of the side of the road, that is, the shoulder of the road. Accordingly, should the driver need to pull off the road, the visible light view locates the edge of the road to assist the driver. Visible light views also provide the driver with a clear indication of clearance when passing under a bridge, or backing toward a loading dock.

In a preferred embodiment, seven other sensor arrays (collectively 40) similar to the first sensor array are disposed about the host vehicle. Preferably, an array is mounted on each corner of the host vehicle, with two mounted on each side of the vehicle, for example, equidistant from the corners and from each other. Alternately, the sensors may be located in a fashion to provide redundant coverage to typical blind spots of the vehicle. Such an arrangement might find multiple sensor arrays concentrated near the rear of the vehicle. Other arrangements and numbers of sensor arrays are also contemplated within the scope of the invention.

A central processing unit (CPU) 50 integrates the three views (radar, IR, visible light) together. The CPU 50 recognizes the strengths of each detection modality and combines them to produce a more accurate interpretation of the given data than possible from a single view. For example, a solid metal contact (automobile) approaches the host vehicle from behind. The CPU 50 obtains position and velocity data of the contact from the radar processor 16. Position and velocity data from the IR and visible light processors 24, 34 are cross-referenced with the position and velocity data from the radar processor 16 to confirm that all three arrays are monitoring or evaluating the same contact. The CPU 50 extracts shape and size information from the IR and visible light processors 24, 34 to form a combined profile of the contact.

Ideal conditions for this type of profiling are moderate temperature, bright, clear days. Of course, not all days are so optimal. Monitoring/evaluating the same contact at night, the radar operates similarly to discern the position and velocity of the contact. However, when cross-referencing, the CPU 50 relies more heavily on the IR array for shape and size information, as it is likely that the visible light sensors 30, 32 only detect, for example, two bright lights.

In another example, a deer runs out in front of the host vehicle. It is likely that the radar does not effectively detect the deer. The CPU 50 relies more heavily on the IR and visible light arrays for all of the information, including velocity and position.

The CPU 50 also tracks the contact as it passes from one monitored region to another around the host vehicle, i.e., as the contact passes from a region monitored by one sensor array to another. The CPU also includes information of the relative positions of the monitored regions about the vehicle so that with this set of constant information, the CPU 50 can smoothly “pass” a contact from one array to the next. That is, the CPU 50 predicts when a contact will leave a region and enter another, etc. and does not treat it as a new contact.

Trailer angle sensors 52, 54 are disposed on the rear of the cab, on the left and right sides. These sensors detect a distance between the cab and the trailer. In a preferred embodiment, the angle sensors 52, 54 are ultrasonic echo locators. Optionally, they may be optical, such as laser detectors, or mechanical, such as springs and force sensors strung between the cab and the trailer. During straight line driving, the first or left angle sensor 52 senses a distance that is equal to a distance sensed by the second or right angle sensor 54. When the truck is turning, the sensors detect varying distances, indicating that the truck is turning. The detected distances are conveyed to the CPU 50 that computes an angle of the trailer relative to the cab. From this angle, the CPU 50 can calculate where the sensors 10, 40 are directed and maintain the continuity of the detected contacts when the truck is turning. This is especially helpful to the driver during slow maneuvering such as backing.

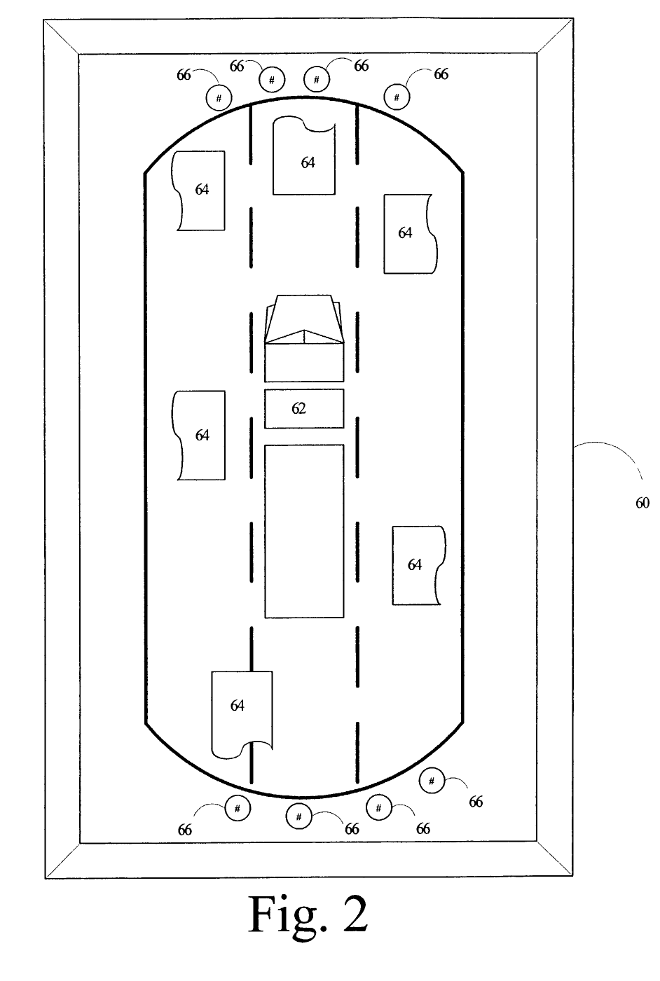

Once a combined profile of a contact is computed by the CPU, it is displayed to the driver, so that the driver is aware of the situation around the vehicle. In a preferred embodiment, the information is displayed in pictorial form on a dash mounted active matrix display 60. A representative display 60 is shown in FIG. 2. The display includes a dynamic representation of the host vehicle such as a tractor/trailer vehicle 62. The shape and size of the host vehicle are portrayed, as well as the angle of the trailer with respect to the cab as detected by the angle sensors 52, 54. Also displayed are contacts 64 and their relative shapes and sizes, as detected by the sensor arrays 10, 40. The preferred active matrix display 60 updates contact information in real time and utilizes color display capabilities. Radar has a much longer range than either infrared or visible light. Radar contacts that have not yet been profiled for size and shape appear as numbered circles 66 on the display, their position on the display indicating their relative direction from the host vehicle.

Also included in the cab of the host vehicle is an input device 68 (FIG. 1). This device allows the driver to input specifications about the host vehicle, such as trailer dimensions, (height, width, and length) cab dimensions, load status, (cargo and weight) date of last brake service, etc. to the CPU 50. Factors that affect the performance of the host vehicle are preferably input to the system before a haul so that the CPU 50 can take them into account. Alternately, data could also be accepted from a data link, for example, an on-board scale system could receive information such as the load status via a data link. The input device also allows the driver to select how many extra radar contacts are displayed.

Contacts are displayed according to a degree of priority/threat to the host vehicle as determined by the CPU 50. Minimal threats are portrayed, for example, as green shapes with no strobe or flashing rate. Moderate threats are displayed as yellow or orange shapes with a slow strobe rate. Serious threats to the host vehicle are portrayed as red shapes that strobe very quickly. Of course other systems for portraying the seriousness of the contact to the driver could be used, although the described combination is believed to be intuitive to the driver. Some factors that the CPU 50 considers when assigning a priority value to contacts are closure on the host vehicle, velocity of the host vehicle, lateral road movement of the contact, size of contact, size of aperture contact encloses, etc. Also considered in assigning a status are the factors concerning the host vehicle that the driver input before commencing the trip. Provided below are some examples to aid in understanding, but are by no means limiting in scope.

Contacts determined to be other automobiles traveling at similar speeds to the host vehicle (small or negative closure rates) are assigned a low status. However, the status of such vehicles is upgraded if their proximity to the host vehicle passes preset thresholds. A vehicle that is swerving in and out of traffic erratically is assigned a moderate to high threat status, depending on closure rates and proximity to the host vehicle. Stationary objects in front of the host vehicle (i.e. closure rate equals the current velocity of the host vehicle) are assigned moderate to high threat status, depending on the speed of the host vehicle and distance from the object.

In an illustrative example, a deer steps out into a freeway in front of the host vehicle. It is assigned a high threat status because closure to the host vehicle is very high. The same deer stepping out behind the host vehicle receives a low threat status, as closure on the host vehicle is negative. The deer standing on the side of the road ahead of the host vehicle receives a moderate threat status because it is a possible threat to the host vehicle and the driver should be made aware of its presence. An overpass that is too low for the host vehicle to pass under receives a high threat status. The side of the road may also receive an increased threat status if the driver maneuvers the host vehicle too close. A tractor/trailer with an oversize load is assigned no lower than a moderate threat status, to allow the driver to compensate.

The system described above exemplifies a situational awareness system that provides an intuitive method of displaying information regarding the driving environment surrounding the vehicle for immediate identification so that a driver is not required to spend time deciphering a cryptic message. A real time scaled representation of what the sensor “sees” is presented as a two dimensional view of the host vehicle and its immediate environs. The use of color/flash coding of the images to represent potential hazards and levels of threat to the host vehicle is a further innovation. The use of an aggregate sensor array including RADAR sensors, visible light cameras and infrared cameras, or any two of these, in conjunction with distributed processing for image recognition provides a more effective means of target tracking than either visible light or infrared systems alone.

While the invention has been described in terms of RADAR, visible light, and infrared sensors and detection, other methods of detection, such as ultrasound echo detectors, ultraviolet or other non-visible light detectors, or other detection devices may be used in addition to or in place of those described above. Moreover, detection of contacts is not limited to the substantially horizontal plane around the vehicle, but may also extend to detect contacts above or below the vehicle. Thus, the invention also has application to vehicles that travel in vertical planes, such as submarines, aircraft, or spacecraft.

The driver display uses an active matrix color LCD screen of sufficient size for viewing, yet is small enough to fit in a dashboard. The display provides a unique complement to a sophisticated system that presents the collected information in a prioritized, intuitive manner.

The invention has been described with reference to a preferred embodiment. Unless otherwise specified, individual components discussed herein are of conventional design and may be selected to accommodate specific circumstances without departing from the spirit and scope of the invention. Modifications and alterations will occur to others upon a reading and understanding of the preceding detailed description. It is intended that the invention be construed as including all such modifications and alterations insofar as they come within the scope of the appended claims or the equivalents thereof.

Having thus described preferred embodiments, the invention is now claimed to be:

1. A near object sensor for a heavy vehicle comprising:
at least two of:
a radar assembly;
an infrared detection assembly; and
a visible light detection assembly.

2. The near object sensor of claim 1, wherein the at least two assemblies gather data about a common region adjacent the near object sensor.

3. The near object sensor of claim 2, wherein the third assembly also gathers data about the common region.

4. The near object sensor of claim 1, wherein the radar assembly includes:
a radar transmitter for emitting radio waves;
a radar sensor for detecting reflected radio waves sent by the radar transmitter;
a radar processor that interprets the reflected radio waves and determines:
positions of objects relative to the near object sensor that reflect the radio waves;
velocities of the objects relative to a velocity of the near object sensor.

5. The near object sensor of claim 1, wherein the infrared detection assembly includes:
a first infrared sensor for sensing a first view of a region adjacent the near object sensor;
a second infrared sensor for sensing a second view of the region adjacent the near object sensor; and
an infrared processor that combines the first view and the second view into a combined infrared view.

6. The near object sensor of claim 1, wherein the visible light detection assembly includes:
a first camera for generating a first view of a region adjacent the near object sensor;
a second camera for generating a second view of the region adjacent the near object sensor; and
a visible light processor for combining the first view and the second view into a combined visible light view.

7. The near object sensor of claim 6, wherein the cameras are CCD cameras.

8. A vehicle comprising
a plurality of sensors as set forth in claim 1;
a central processing unit for integrating views from each of the plurality of sensors; and
a display for displaying the integrated views to an operator of the vehicle.

9. A situational awareness system for a vehicle comprising:
a plurality of periphery sensors, each periphery sensor comprising at least two of:
a radar assembly;
an infrared detection assembly;
a visual light detection assembly; and
a display for displaying to a driver of the vehicle information gathered by the plurality of periphery sensors.

10. The situational awareness system of claim 9, wherein the radar assembly includes:
a radar transmitter for transmitting radio waves into a region adjacent the vehicle;
a radar sensor for receiving echoes of the transmitted radio waves from the region; and
a radar processor for processing the radio echoes into information about objects in the region.

11. The situational awareness system of claim 10, wherein the infrared detection assembly includes;
a first infrared sensor for generating a first infrared view of the region;
a second infrared sensor for generating a second infrared view of the region; and
an infrared processor for combining the first and second infrared views into a single binocular infrared view.

12. The situational awareness system of claim 10, wherein the visual light detection assembly includes:
a first camera for generating a first visible light view of the region;
a second camera for generating a second visible light view of the region; and
a visible light processor for combining the first and second visible light views into a single binocular visible light view of the region.

13. The situational awareness system of claim 11, further including:
a central processing unit for cross-referencing the radar information with the binocular infrared view, and for providing display parameters pertaining to objects in the region to the display.

14. The situational awareness system of claim 12, further including:
a central processing unit for cross-referencing the radar information with the binocular visible light view, and for providing display parameters pertaining to objects in the region to the display.

15. The situational awareness system of claim 13, wherein the display parameters include:
size of objects in the region;
shape of objects in the region;
position of objects in the region;
color of objects in the region; and
rate of strobe of objects in the region.

16. The situational awareness system of claim 9, further including:
a first angle sensor disposed on a rear of a truck cab for determining an angle between the truck cab and a trailer; and
a second angle sensor disposed on the rear of the truck cab for determining the angle between the truck cab and the trailer.

17. A method of near object detection for a heavy vehicle comprising the steps of:
emitting radio waves into a region;
receiving reflected radio waves from objects within the region to generate radar information about the objects; and
receiving a second set of emissions from the region.

18. The method of claim 17, wherein the second set of emissions is selected from the group consisting of infrared emissions and visible light emissions.

19. The method of claim 17, further including the steps of:
cross-referencing the radar information with the second set of received emissions to generate combined information about objects within the region.

20. The method of claim 19, wherein the cross-referencing of combined information includes the steps of:
assessing a shape of an object;
determining a size of the object; and
calculating a position of the object.

21. The method of claim 20 further including the steps of:
displaying the shape, size, and position of the object on a display; and
displaying a threat level of the object on the display.

22. The method of claim 20 comprising the further step of calculating relative velocity between the vehicle and the object.

23. A situational awareness system for a vehicle comprising a plurality of periphery sensors, each periphery sensor comprising assemblies capable of detecting at least two types of emissions or reflected waves, and a display for displaying to a driver of the vehicle information gathered by the plurality of periphery sensors.

24. The situational awareness system of claim 23, wherein the emissions or reflected waves are selected from the group consisting of radio waves, infrared light, and visible light.
